(19) United States
(12) Patent Application Publication
(10) Pub. No.: US 2025/0162012 A1
(43) Pub. Date: May 22, 2025

(54) SYSTEM, METHOD, AND COMPUTER PROGRAM PRODUCT FOR CNC EXPORT AND FRAMING MANUFACTURING

(71) Applicant: Wall to Wall, LLC, Hayward, CA (US)

(72) Inventors: Noam BURG, Tel Aviv (IL); Noam RONEN, Be'er Tuvia (IL); Alon KLEIN, Herzliya (IL); Eran GALPERIN, Tel Aviv (IL); Tomer Adam GOLDGRABER, Haifa (IL)

(73) Assignee: Wall to Wall, LLC, Hayward, CA (US)

(21) Appl. No.: 18/725,742

(22) PCT Filed: Dec. 29, 2022
(86) PCT No.: PCT/IL2022/051412

§ 371 Date: Jun. 28, 2024

Related U.S. Application Data
(60) Provisional application No. 63/294,579, filed on Dec. 29, 2021.

(51) Int. Cl. B21B 38/04

(52) U.S. Cl. CPC B21B 38/04

(57) ABSTRACT

A CNC-controlled roll-forming method comprising manufacturing at least one individual building component for subsequent, typically ex post facto building of a structure by connection of the individual building component with additional building components, using a roll-forming machine which has a controller configured to read machine-readable CNC instructions, and/or using the roll-forming machine for adding at least one marking to the individual building component, e.g. during manufacture of said individual building component, wherein said marking facilitates subsequent connection, of the building component, to at least one additional building component.

### CROSS-REFERENCE TO RELATED APPLICATIONS

This application is a U.S. National Stage application under 35 USC 371 of International Application No. PCT/IL2022/051412, filed Dec. 29, 2022, which claims the benefit and priority of U.S. Provisional Application No. 63/294,579, filed Dec. 29, 2021. The entire contents of each priority application are incorporated by reference herein.

### FIELD OF THE DISCLOSURE

The present invention relates generally to CNC, and more particularly to roll formers.

### BACKGROUND OF THE DISCLOSURE

According to thomasnet.com, “Printed metal is used by industry for a variety of purposes from nameplates to barcoded tags for asset management. Popular metals for these industrial applications include stainless steel, aluminum, zinc, and brass. Among the processes are screen printing, direct digital printing, embossing, laser marking, chemical etching, anodized photosensitive processing, and stamping. Each process has its pros and cons”—as described here: https://www.thomasnet.com/articles/custom-manufacturing-fabricating/how-to-print-on-metal/.

Roof- and floor-cassettes are known e.g., as described here: https://www.carters.co.nz/floor-cassette-solutions https://www.nationaltimbersystems.co.uk/products/roof-and-floor-cassettes/ Roll-forming is known e.g., as described here: https://en.wikipedia.org/wiki/Roll forming.

The term “profile” is used to define the shape of a manufactured article's cross section, for a manufactured article which has a uniform cross-section. For example, an I-beam or H-beam is a manufactured article which has a uniform cross-section shaped like the letter H or I, whereas a cylindrical pipe typically has a uniform circular cross-section; both of these, since they have a uniform cross-section, may be termed “constant-profile” articles.

Frame structures, aka framing structures, are known. Examples are described in Wikipedia's entry on “steel frame”, e.g. the section on Cold-formed steel frames and in the third section (re Light Gauge Steel Construction) inter alia, in the following online reference: theconstructor.org/structural-engg/steel-frame-structure-building-construction/24906/.

The disclosures of all publications and patent documents mentioned in the specification, and of the publications and patent documents cited therein directly or indirectly, are hereby incorporated by reference other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF THE DISCLOSURE

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

Certain embodiments seek to provide an improved method for manufacturing components to be hand-assembled, including adding indicia to the components as they are manufactured e.g., adding different indicia e.g., symbols and/or alphanumeric characters to identical components in the course of fabricating these components. An example of a machine which may be used for fabricating such components is a roll-former.

Indicia may include indications of how to orient a first component when it is being fastened to a second component; this indicia may be added to the first and/or second component and may be close to a location (e.g. “connection point”) at which the two components are to intersect, such that a human assembler may see the indicia when he is assembling the two components. An indication of how to orient may include a representation of the cross-section of the component, properly oriented. For example, if a constant-profile component such as a stud or track has a uniform C shaped cross section defining an open end of the component, the indicia may include “C”, backward C, U, or backward U if the component's open-end is to face right, left, upward, or downward, respectively, where right/left/up/down may, for example, be defined relative to the surface bearing the indicia. So typically, if component1's open-end is to face right, relative to a certain surface of component2 to which component1 is to be fastened, component2's surface (inter alia) may bear indica which includes “C” whereas if component1's open-end is to face left, relative to the same surface of component2, component2 (inter alia)'s surface may bear indica which includes a backward letter “C”.

It is appreciated that any holes or other mechanical markings, and text (indicia) described herein may be applied to articles which are not necessarily building construction components and/or are not necessarily elongate and/or are not necessarily roll-formed.

It is appreciated that a wide variety of articles may be manufactured by electronically controlled machinery capable of forming indicia and/or mechanical markings; typically the precision with which the machine generates mechanical markings exceeds the machine's precision in imprinting indicia.

Certain embodiments seek to facilitate convenience of handling of framing structures (such as but not limited to wall panel elements, floor cassette elements, and roof cassette elements) which are typically a portion of prefabricated modular building elements.

Certain embodiments seek to provide an improved roll-forming machine including a printer

Example roll-forming machines aka roll formers are the framing machines shown here: https://knudsonmfg.com/roll-forming-machine-services/.

The roll-forming machine may have or lack integral printing capability; if the latter, a printer may for example be added externally e.g., at the machine output, where the rolled workpiece comes out, and may perform its printing function, on the workpiece, at that point. Integration between the roll-forming machine and printer may be through the control unit which processes and decodes the CNC commands, and, accordingly, determines whether to send a command to the roll-forming machine, or to the printer.

During assembly of building elements, earlier manufactured by a machine such as a roll-forming machine, the assembler may use drawing/s for retrieving instructions needed for the assembly itself. For example, the exact position of a certain stud (say) on a track (say) might be noted in the drawing with a specific distance measurement. The assembler then needs to read the instructions and the measurement value, and then to locate the stud position by actually measuring the distance (from some dictated reference point on the track). Certain embodiments seek to provide a cue which will accurately indicate this position e.g., by providing a textual indication (which, having been generated by a printer whose accuracy is low relative to the mechanical capabilities of the machine, may be less accurate) for pointing out a physical location/position and/or an actual mechanical indicator or landmark (punch hole) whose position may be set precisely (by the machine).

Certain embodiments seek to improve current manufacturing methodologies by addressing all or any subset of the following aspects of the framing structure assembly problem.

Certain embodiments resolve the accuracy issues related to printing cues (aka indicia) on top of the framing structure component itself e.g., by utilizing a combination of distinctive features, and enables the use of existing machinery for manufacturing. Since printing labels is not an accurate process in terms of localization, the label itself cannot be used for measurement. However, if the printed label is combined with an accurate punch/hole/cut or other cue which a roll-former machine may perform with highly accurate localization, then, in combination, this yields an accurate instruction.

Certain embodiments bypass inherent printing and roll-forming limitations by presenting clear visual cues on the frame structure components which may include an accurate (e.g. accurately localized) punch/hole/cut or other cue generated by the roll-former, rather than by providing a printer capable of accurate localization.

Certain embodiments simplify the assembly process by presenting the visual cues facing a single direction with no need to flip or physically move the component or the worker.

as shown in FIGS. 9b and 9c, representing a data structure before and after simplification respectively. The simplified data structure, e.g. connectivity matrix, may then be stored for subsequent convenient use for various applications including generation of CNC files and/or assembly validation and/or facilitation of automation processes. Instead of directly processing a complex 3D structure e.g. a 3d model, generated say by Revit, the system may generate (derive from the 3d model e.g.) and use a simplified data structure e.g., as described herein. Validation may, for example, include verifying that the list of data structure points exist, instead of trying to overlap the 3D drawing with the actual build-up.

to certain embodiments, assembly validation may be performed by a human operator who determines that frame components have been properly fastened together, according to the 3D model. To perform this quality assurance task, the human operator may need to observe the connectivity aspects of the 3D model from plural views. If, to achieve this, the human operator repeatedly rotates and/or scales the actual 3D model, each rotation and/or scaling involves computations which may require many tens of seconds, or even more than a minute, to perform. In contrast, if a connectivity matrix or other simplified data structure is generated, rotation and/or scaling of the simplified data structure requires far less computations such that the quality assurance task can proceed much more rapidly even if during this task, the human operator requests a long series of views. Alternatively or in addition, the muman operator performing this quality assurance task may observe the printed indicia on the assembled frame and, accordingly, determine whether or not the framing components have been fastened together according to plan.

Any suitable method may be used to derive the simplified data structure, which typically includes only connectivity details between elements which need to be fastened, from the original 3D model. For example, the 3D model may be scanned either along the studs, or along the tracks, or in any other suitable order. It is appreciated that deriving a CNC command file which enables the connectivity to be implemented typically includes ordering all connectivity details pertaining to a given framing element (stud or track e.g.) in the order in which the CNC machine will actually work. For example, if the 3D model may be scanned stud by stud, starting from the top stud and proceeding to the bottom stud, where the odd-numbered studs are scanned right to left whereas the even-numbered studs are scanned left to right. If the CNC machine processes all studs from right to left, the connectivity details for each of the even-numbered studs may be reversed. Also, the connectivity details for each track are accumulated, and ordered from right to left (if tracks are processed by the CNC machine from right to left).

The term “Cue” as used herein is intended to include any indicator or indicia added to a building element which may be manufactured by the roll-forming machine, e.g. by printing or engraving thereupon, which may be used during the assembly process (e.g. when a human assembler subsequently interconnects structural elements manufactured by the roll-forming machine), thereby to reduce or eliminate the need to repeatedly consult a separate engineering drawing.

The cue may include a printed label including, say, a symbol such as “]” to indicate that the relevant part should be positioned with its open side facing left, or “[” to indicate that the relevant part should be positioned with its open side facing right, or “*” indicating a location at which a relevant part should be screwed, or, perhaps, a textual message such as “cut here” or relevant symbol such as a dotted line (along which to cut). And/or, the Cue may include a mechanical feature added to the building element e.g. a “spy hole” pre-formed accurately by the machine, wherein the mechanical feature's location is determined by the location at which one structural element is to be interconnected with another.

Certain embodiments seek to facilitate operations by modular construction companies, architects, mechanical engineers, etc.

Certain embodiments seek to improve current manufacturing methodologies by addressing different aspects of the framing structure assembly. Users, especially construction workers, are offered a streamlined and simplified assembly process e.g. facilitation of manual assembly by providing helpful indicia and/or actual physical markings on components to be assembled, at suitable locations e.g. as described herein. Typically, errors in manufacturing are minimized, while production rate levels increase. Waste of materials (due to errors) is therefore minimized. Automation of at least a portion of the (typically manual, typically on-site rather than at the factory) assembly process e.g., most of the process, is facilitated by embodiments of this invention.

Certain embodiments seek to provide an improved method for manufacturing (prefabricated) building elements, including: providing a manufacturing machine system including a high-accuracy machine for mechanically featuring a building element, and a low-accuracy machine for adding indicia to the building element, and/or using the high-accuracy machine to add a mechanical feature landmarking, with a first accuracy, a first location at which the building element is to be post-processed manually by a human operator; and/or using the low-accuracy machine for adding indicia to the building element at a second location, determined at an accuracy lower than the first accuracy, which is adjacent enough to the first location to be visible to the human operator when the human operator interacts with the mechanical feature; thereby to reduce a need for a human operator to consult engineering drawings when post-processing the building element manually.

Post-processing may include connecting an additional building element to the building element. The high-accuracy machine may comprise a roll-forming machine, and the low-accuracy machine may comprise a printer.

According to some embodiments, a cache including a data structure is provided, which stores connectivity details of a component Y to be installed into or on a component X, for each of plural components X and each of plural components Y.

According to some embodiments, the data structure comprises a matrix.

According to some embodiments, in the matrix, the cell at Row x, Column y and the cell at Row Y, Column X, describe the connectivity arrangement between the same components x, y, but from different perspectives.

According to some embodiments, the data structure also stores intrinsic data relevant to a component itself, such as its own dimensions, or any other mechanical or geometric aspects of the component itself.

According to some embodiments, the diagonal cells of the matrix store intrinsic data relevant to a component itself, such as its own dimensions or any other mechanical or geometric aspects of the component itself.

According to some embodiments, the data structure is maintained dynamically.

According to some embodiments, a CNC roll-forming method is provided, comprising using rollers, mounted consecutively, to incrementally bend a strip of metal e.g., steel, fed through the rollers, into a profile with a desired configuration and adding at least one feature to the profile, which facilitate/s later connection of the profile, to other profile/s, by a human, relative to repeatedly consulting an engineering drawing describing the desired connection of the profile, to other profile/s.

According to some embodiments, the at least one feature comprises a textual indication appreciable by a human.

According to some embodiments, the at least one feature comprises a mechanical indicator.

According to some embodiments, the method wherein the mechanical indicator comprises a punch hole.

According to some embodiments, a method for facilitating interconnection of framing components is provided, including
for at least one connection point between at least first and second framing components, adding additional assembly information for at least the first one of, typically all of, the components, adjacent a mechanical feature used to interconnect the components, the information comprising a printed label which is selected to identify (e.g., by stipulating a part number of) the second component to be connected e.g., attached or inserted into) the first component; and/or
indicate an orientation which the second component should assume, when being connected to the first component.

According to some embodiments, aid framing components are manufactured by the roll-forming machine.

According to some embodiments, the mechanical feature comprises an aperture punched at a precise (e.g., say, ½ or ¼ or ⅛ or 1/16 inch accuracy) location of an edge of an installed component which may be visually inspected for the correctness of the placement.

According to some embodiments, a method for accommodating for bi-directional printing while roll-forming is provided, the method comprising all or any subset of the following operations:

| 1) | Next framing component is retrieved | |
|---|---|---|
| 2) | Determine 3D orientation of the framing component: | |
| | a. | If component is a stud, then determine if target position in assembly is open to the |

right (C) or to the left (backward C).

| | i. If not in proper position, the proceed with the reversing process (e.g., as |
|---|---|
| described with reference to operation 3) | |
| | ii. If in proper position, proceed with normal printing and punching process |
| b. | If component is a track, then determine if target position in assembly is open |

upward like the letter U or downward like an upside down letter U.

i. If not in proper position, then reverse e.g. proceed with the reversing

process (e.g., as described with reference to operation 3)

ii. If in proper position, proceed with normal printing and punching process

| | |
|---|---|
| 3) | Perform reversing process e.g., by performing all or any subsets of the following, in any |

suitable order e.g., as follows:

| | |
|---|---|
| a. | Retrieve stud or track length as L |
| b. | Open new text vector V (dimension N equal to the number of printouts) |
| c. | Initialize i with N (i = N) |
| d. | Retrieve next punch position Xi and associated label record Li |
| e. | At least once reverse stud or track orientation characters e.g., C, U, reversed C, or |

upside-down U. Left-faced may be changed to right-faced and vice versa, and/or upper faced may
be changed to lower faced and vice versa.

| | |
|---|---|
| f. | Generate CNC text command with adjusted position (L-Xi) and printed label Li |
| g. | Store CNC text command in Vi |
| h. | Reduce i by 1 |
| i. | If i > 0, then go to operation d, otherwise go to next operation |
| j. | Append vector V to CNC instruction file |

| | |
|---|---|
| 4) | Terminate if no more framing components, otherwise return to operation 1 |

According to some embodiments, a method for printing while roll-forming is provided, the method comprising label adjustment.

According to some embodiments, the label adjustment includes all or any subset of the following operations:

1) Create a modified label list L′ which may be initialized to the original label list (L) values
2) Initialize pointer R to 0 (R = 0),
3) Process next label, L[i], to be positioned at X[i] (starting point)
4) If no more labels exist end process by going to operation 8
5) If i = 1 (first label) then compute the physical length of the label, Len(L[i]) and adjust R to
point to the end of the first label and return to operation 3
6) If i > 1 (subsequent label not first label) then:

| a. | Check if adjacent labels “too close”, (X[i] − R) < P | |
|---|---|---|
| b. | If “too close”, then modify preceding label L'[i − 1] | |
| | i. | Take original preceding label |
| | ii. | Pad L′[i − 1] with spaces (number of spaces determined by the dividing the |
| | | distance X[i] − R by the character width) |
| | iii. | Append label L[i] to L′[i − 1] |
| | iv. | Set L′[i] to null |
| | v. | Set new R value to point to L′[i − 1] label end (add physical length of L′[i − 1] |
| | | to current R) |

| | |
|---|---|
| c. | If not “too close”, then no modifications are required and only set the new R value |
| | to point to L′[i] label end |

7) Go to operation 3
8) Use modified label list L′ instead of original label list L

Thus a “program file” may be created which may be used to control the roll former and printer to respectively produce and mark a specific object (e.g., stud).

According to some embodiments, one or both of the following problems are resolved computationally: the assembler, when handling a framing object, may be forced to change sides for reading the labels on both sides of the framing; printing in advance on a given side which may be faced cannot be done directly if printed labels and punches are placed wrongly in terms of order and/or position.

According to some embodiments, processing circuitry is provided comprising at least one processor and at least one memory, and is configured to perform at least one of or any combination of the described operations, or to execute any combination of the described modules.

According to some embodiments, any suitable combination of the systems or methods shown and/or described and/or claimed herein are provided.

It is appreciated that any reference herein to, or recitation of, an operation being performed is, e.g. if the operation is performed at least partly in software, intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations, and, instead, the remote processor P itself may receive output/s of portion/s of the operations from yet another processor/s P′, may be deployed off-shore relative to P, or “on a cloud”, and so forth.

According to some embodiments, a CNC-controlled roll-forming method is provided, comprising manufacturing at least one individual building component for subsequent, typically ex post facto building of a structure by connection of the individual building component with additional building components, using a roll-forming machine which has a controller configured to read machine-readable CNC instructions, and/or using the roll-forming machine for adding at least one marking to the individual building component, e.g. during manufacture of the individual building component, wherein the marking facilitates subsequent connection, of the building component, to at least one additional building component.

Subsequent connection of building components may be manual and may occur in the factory and/or at the building site.

It is appreciated that any machine/s may be used, which may have a main functionality performed at a first level of precision and a printing functionality performed at a second, lower, level of precision such that, say, a difference between (say) a location of a hole punched by the machine (or any other local mechanical/physical operation performed on the workpiece by the machine's main functionality) and a location at which the hole was to be punched is smaller on average, than the difference between location of indicia printed by the machine and the location at which the indicia was to be printed.

More generally, a CNC-controlled method is provided which includes manufacturing at least one individual building component for subsequent, typically ex post facto building of a structure by connection of the individual building component with additional building components, using a machine which has a controller configured to read machine-readable CNC instructions, and using the machine for operating on e.g. adding at least one marking to, the individual building component, e.g. during manufacture of the individual building component, wherein typically, the marking facilitates subsequent connection, of the building component, to at least one additional building component. The marking may be affixed by apparatus which is not governed by the machine's high-precision localization functionality.

It is appreciated that some building components are intended to be deployed, during building, with their main axis vertical (these may be termed studs) and others with their main axis horizontal; these may be termed beams or tracks. beams, which may be horizontal, and studs, which are vertical, are non-limiting examples of building components which typically comprise elongate members. These may be connected or joined or fastened to one another (typically a vertical member to a horizontal member or vice versa) using any suitable technology for joining or fastening such as, by way of non-limiting example, rivets, pins or bolts or screws. Tracks may be deployed on a structural member comprising a flat top surface to which the tracks may be bolted. If, for example, the profile of each stud and track is c-shaped, each stud's profile's dimensions may be small enough to fit inside the track whose dimensions may be larger, and the perpendicular end-portions of the stud's c-shaped profile may be screwed or otherwise fastened to the perpendicular end-portions of the track's c-shaped profile. Example: a c-shaped first “inner’ track may be seated within a c-shaped second (“outer”) track; the inner track rather than the outer track may then be fastened e.g., screwed to the stud, to enable vertical movement.

According to some embodiments, the at least one individual building component comprises first and second articles, wherein the first article's connection to at least one additional article differs from the second article's connection to at least one additional article, and wherein the first and second articles are identical, except for plural first and second markings on the first and second articles respectively.

According to some embodiments, the first and second articles are identical in cross-section, thereby to provide constant-profile articles other than differences in the marking, which facilitates each individual constant-profile article's subsequent connection to at least one constant-profile article.

According to some embodiments, the method further comprises subsequent connection, of the building component, to at least one additional building component.

According to some embodiments, the subsequent connection is performed manually.

According to some embodiments, the manufacturing includes detaching the building component from a roll of raw material fed into the roll-forming machine, e.g., by cutting, and wherein the adding occurs before the detaching.

According to some embodiments, the marking comprises printed indicia and the adding comprises printing the indicia on the individual building component.

According to some embodiments, the indicia are printed on a location selected to be visible not just before the individual building component is connected to the at least one additional building component, but also after the individual building component is connected to the at least one additional building component.

According to some embodiments, a method wherein at least one of the indicia is printed on a location selected to be visible not just before the individual building component is connected to the at least one additional building component, but also while the individual building component is being connected to the at least one additional building component.

According to some embodiments, the indicia comprise text which is read in a given order and is printed in an order other than the given order, such that alphanumeric characters, which are read later, are printed earlier.

It is appreciated that indicia may comprise alphanumeric characters which are flipped horizontally (e.g. an upside down M which would then resemble a W) and/or vertically (e.g. a C whose open end would point to the left rather than to the right). The printer memory may be provided with 2 additional fonts comprising horizontally reversed letters and vertically reversed letters respectively. Any suitable fonts may be provided e.g. bitmap fonts or outline fonts describing the outline of each letter, to enable the printer to render letters in various sizes.

According to some embodiments, the indicia comprise text and wherein the printing comprises punching a mirror image of the text on a first side of each building component for only a subset of building components manufactured by the method to enable the text to be read from a second, opposite, side, wherein the subset includes building components whose second side will be visible, when later connected to other building components, and does not include building components whose first side will be visible, when later connected to other building components.

According to some embodiments, the indicia comprise an indication of a desired orientation of the individual building component, when the individual building component is being connected to additional building components.

According to some embodiments, the indication comprises a representation of the individual building component's cross-section, oriented as the cross section is desired to be oriented, when the individual building component is being connected to additional building components.

According to some embodiments, the marking comprises at least one hole in the individual building component.

According to some embodiments, the hole is deployed at a position P, along the individual building component, at which another building component B is to be connected to the individual building component.

According to some embodiments, the roll-forming defines an axis of operation along which the roll is paid into the machine, and wherein the position comprises an axis perpendicular to the axis of operation.

According to some embodiments, the hole is circular defining a center-point of the circle which is deployed at the position e.g. along an axis perpendicular to the roll-forming's axis of operation such that, once B is connected, a human operator can look through the hole (aka “spy hole”) and discern that half of the hole is now blocked by component B, whereas none of the hole was blocked before component B was connected.

It is appreciated that each time some, but less than half, of the (typically circular) hole's area is blocked, this indicates to a human operator that B is connected to a first side of the position P rather than at position P whereas each time more than half of the circular hole's area is blocked, this indicates to a human operator that B is connected to a second side of the position P rather than at position P, thereby to enable the human operator to easily determine whether and how component B's position, relative to the individual building component, needs to be changed.

It is appreciated that a spy hole in a first component, deployed at a location at which an edge of a second component is to be deployed when the second component is to be fastened to the first component, has wide applicability to any manual or automated assembly situation since this allows the view through the spy hole to be indicative of whether or not the second component is fastened to the correct location along the first component.

According to some embodiments, the adding is controlled by the machine-readable CNC instructions.

According to some embodiments, the machine-readable CNC instructions, which control the adding, are non-identical for at least one pair of building components, manufactured by the roll-forming machine, which are identical in structure, but, nonetheless, are differently connected to other building components.

According to some embodiments, the marking is a local marking which occurs at one location along the individual building component, rather than along the individual building component's entire length.

According to some embodiments, a cache including a data structure is provided, which stores connectivity details of a component Y to be installed into or on a component X, for each of plural components X and each of plural components Y.

The cache may be stored in a high-speed data storage layer and may store only a subset of a 3D model of a structure which includes plural components which are to be fastened to one another, including components X and Y. The complete 3D model may be stored in an underlying slower storage layer and may include details other than the connectivity details e.g. all data included in a Revit or AutoCAD 3D model of a building element e.g. wall or floor cassette. The cache need not be transient in nature, but the cache enables requests for data which only require connectivity details, to be served up faster than would have been possible if the underlying storage layer were to be accessed. The cache may be accessed plural times for plural uses and thereby, may use and then efficiently reuse connectivity details which may have been previously derived from the complete 3D model.

The connectivity details data may be stored in fast access hardware such as RAM (Random-access memory) which increases data retrieval performance relative to having to access the 3D model which may be stored in an underlying slower storage layer.

More generally, certain embodiments herein seek to provide a cache including only a subset of complete 3D model data to enable certain data uses (such as quality assurance or automatic CNC file generation), which require only the subset (e.g. only connectivity details) to be performed faster because the data these data uses require can be served up faster and/or because the efficient subset of data may be used and reused.

According to some embodiments, the data structure comprises a matrix.

According to some embodiments, in the matrix, the cell at Row x, Column y and the cell at Row Y, Column X, describe the connectivity arrangement between the same components x, y, but from different perspectives.

According to some embodiments, the data structure also stores intrinsic data relevant to a component itself, such as its own dimensions or any other mechanical or geometric aspects of the component itself.

According to some embodiments, the diagonal cells of the matrix store intrinsic data relevant to a component itself such as its own dimensions or any other mechanical or geometric aspects of the component itself.

According to some embodiments, the data structure is maintained dynamically.

According to some embodiments, a method is provided, comprising modifying a command file storing the CNC instructions machine-readable by the controller of the roll-forming machine to include a marking including at least one label and/or at least one shape and/or at least one hole punch, thereby to yield a computer program product comprising the command file as modified, and wherein the controller reads the command file as modified, to control the manufacturing.

The command file may be generated to include all commands to the roll former's controller, or, alternatively, in a first stage, a command file is generated which includes only commands pertaining to manufacturing the desired building component without markings to facilitate later assembly of building components, and subsequently, commands which generate the markings to facilitate later assembly of building components are added at appropriate locations in the command file e.g. commands which generate markings at a first end of the building component which is fabricated first by the roll former, appear at the location within the command file which includes commands pertaining to fabricating the first end, whereas commands which generate markings at a second end of the building component which is fabricated later by the roll former, appear at a later location within the command file together with commands pertaining to fabricating the second end. Markings typically appears on portions of each building component which will be visible to a human assembler at a time in which the marking is relevant rather than appearing on portions of each building component which will not be easily visible to a human assembler at the time in which the marking is relevant.

It is appreciated that a unique identifier may be printed on each building component.

According to some embodiments, a computer program product is provided, comprising a non-transitory tangible computer readable medium having computer readable program code embodied therein, the computer readable program code adapted to be executed to implement a CNC-controlled roll-forming method comprising manufacturing at least one individual building component for subsequent, typically ex post facto building of a structure by connection of the individual building component with additional building components, using a roll-forming machine which has a controller configured to read machine-readable CNC instructions, and using the roll-forming machine for adding at least one marking to the individual building component, e.g., during manufacture of the individual building component, wherein the marking facilitates subsequent connection, of the building component, to at least one additional building component.

According to some embodiments, the system comprises at least one hardware processor configured to carry out the operations of any of the methods herein.

Also provided, excluding signals, is a computer program comprising computer program code means for performing any of the methods shown and described herein when the program is run on at least one computer; and a computer program product, comprising a typically non-transitory computer-usable or -readable medium e.g., non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes, or a general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processors, display and input means may be used to process, display e.g. on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules illustrated and described herein may include any one or combination or plurality of: a server, a data processor, a memory/computer storage, a communication interface (wireless (e.g., BLE) or wired (e.g. USB)), a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. Use of nouns in singular form is not intended to be limiting; thus, the term processor is intended to include a plurality of processing units which may be distributed or remote, the term server is intended to include plural typically interconnected modules running on plural respective servers, and so forth.

The above devices may communicate via any conventional wired or wireless digital communication means, e.g., via a wired or cellular telephone network, or a computer network such as the Internet.

The apparatus of the present invention may include, according to certain embodiments of the invention, machine readable memory containing or otherwise storing a program of instructions which, when executed by the machine, implements all or any subset of the apparatus, methods, features, and functionalities of the invention shown and described herein. Alternatively, or in addition, the apparatus of the present invention may include, according to certain embodiments of the invention, a program as above which may be written in any conventional programming language, and optionally a machine for executing the program, such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers, or other such information storage, transmission, or display devices, or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g., digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g., chips, which may be co-located or remote from one another. Any controller or processor may, for example, comprise at least one CPU, DSP, FPGA, or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs) or may comprise a microprocessor that runs suitable software, or a combination of hardware and software elements.

The present disclosure may be described, merely for clarity, in terms of terminology specific to, or references to, particular programming languages, operating systems, browsers, system versions, individual products, protocols, and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components and, alternatively, may be the same structure. A statement that an element or feature may exist is intended to include (a) embodiments in which the element or feature exists; (b) embodiments in which the element or feature does not exist; and (c) embodiments in which the element or feature exist selectably, e.g., a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface or other system illustrated or described herein. Any suitable computerized data storage e.g., computer memory, may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s e.g. as described herein, which may, for example, include all or any subset of an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus the term user interface, or “UI” as used herein, includes also the underlying logic which controls the data presented to the user, e.g. by the system display, and receives and processes and/or provides to other modules herein, data entered by a user e.g. using her or his workstation/device.

### BRIEF DESCRIPTION OF THE DRAWINGS

Certain embodiments of the present invention are illustrated in the following drawings; in the block diagrams, arrows between modules may be implemented as APIs and any suitable technology may be used for interconnecting functional components or modules illustrated herein in a suitable sequence or order e.g. via a suitable API/Interface. For example, state of the art tools may be employed, such as but not limited to Apache Thrift and Avro which provide remote call support. Or, a standard communication protocol may be employed, such as but not limited to HTTP or MQTT, and may be combined with a standard data format, such as but not limited to JSON or XML. According to one embodiment, one of the modules may share a secure API with another. Communication between modules may comply with any customized protocol or customized query language or may comply with any conventional query language or protocol.

Example embodiments are illustrated in the various drawings. Specifically:

FIG. 1 illustrates an example of a steel roll-forming process.

FIG. 2 illustrates an actual roll-forming machine presenting entry point of the steel sheet and the exit point of the frame structure component, according to an embodiment.

FIG. 3 illustrates a “shop drawing” example—a drawing loaded with detail which may be used by a human assembler.

FIG. 4A illustrates an example of a stud base into a track (e.g., a portion of a frame structure).

FIG. 4B illustrates an example frame structure of a wall panel including multiple studs, tracks, and other components.

FIG. 5 illustrates a print over a frame structure component during a roll-forming process, demonstrating crude printing capabilities.

FIG. 6A illustrates a frame structure with printed cues, according to an embodiment.

FIG. 6B illustrates a specific focus on one of the components of FIG. 6A demonstrating an example use-case for the punch hole and label (the terms “label/s” and “indicia” may be interchanged herein).

FIG. 6C illustrates a printing and hole punching dimension relative to component edge; it is appreciated that hole-punching is but one example, used herein for simplicity, of a physical or mechanical operation performed on a workpiece which typically needs to be performed at a specific location.

FIG. 6D illustrates an example of Program code (CNC) for establishing printout and punching as seen in the example of FIG. 6C.

FIG. 7A illustrates an example of two tracks (lower, upper) with proper printing, taking into account facing directions.

FIG. 7B illustrates a combined view of two tracks (following the example of FIG. 7A) with facing printouts and punched holes (aligned).

FIG. 8 illustrates dimensioning the labels to be printed according to an embodiment.

FIG. 9A illustrates a connectivity matrix structure which may, according to an embodiment, be generated, stored in a cache, and used e.g., to describe or represent or conveniently access relative positions of framing components, or building components forming a framing structure e.g., intersections or connection points at which one building component is fastened to another, and/or used for pin-point description of the framing structure.

FIG. 9B illustrates a simplified 3D view of an image of a frame structure.

FIG. 9C illustrates an example minimalist view of the frame structure of FIG. 9B, enabled by generating a connectivity matrix representation and typically storing as a cache which may be available to a software process which uses a 3D representation of the structure, but instead of retrieving the 3D representation or model and re-analyzing at source, the cache contains a pre-processed version of the 3D model which may yield immediate access, with no need for recompute. If the software wants to validate some aspects of the structure e.g. whether all “junctions” or intersection points between studs and tracks were handled, then instead of recovering/retrieving the 3D file and re-analyzing for finding all the possible “junctions”, the cached version has already all the junctions available, hence no need for the software to find them.

Methods and systems included in the scope of the present invention may include any subset or all of the functional blocks shown in the specifically illustrated implementations by way of example, in any suitable order e.g., as shown. Flows may include all or any subset of the illustrated operations, suitably ordered e.g., as shown. Tables herein may include all or any subset of the fields and/or records and/or cells and/or rows and/or columns described.

Computational, functional, or logical components described and illustrated herein can be implemented in various forms, for example, as hardware circuits, such as but not limited to custom VLSI circuits, or gate arrays, or programmable hardware devices, such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act, or behave, or act as described herein with reference to the functional component in question. For example, the component may be distributed over several code sequences, such as but not limited to objects, procedures, functions, routines and programs, and may originate from several computer files which typically operate synergistically.

Each functionality or method herein may be implemented in software (e.g. for execution on suitable processing hardware such as a microprocessor or digital signal processor), firmware, hardware (using any conventional hardware technology such as Integrated Circuit technology) or any combination thereof.

Functionality or operations stipulated as being software-implemented may alternatively be wholly or fully implemented by an equivalent hardware or firmware module, and vice versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware, in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer, or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option, such as but not limited to FPGA, ASIC, or DSP, or any suitable combination thereof.

Any hardware component mentioned herein may in fact include either one or more hardware devices e.g., chips, which may be co-located or remote from one another.

Any method described herein is intended to include, within the scope of the embodiments of the present invention, also any software or computer program performing all or any subset of the method's operations, including a mobile application, platform, or operating system, e.g., as stored in a medium, as well as combining the computer program with a hardware device to perform all or any subset of the operations of the method.

Data may be stored on one or more tangible or intangible computer readable media stored at one or more different locations, different network nodes, or different storage devices at a single node or location.

It is appreciated that any computer data storage technology, including any type of storage or memory, and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary, or off-line; which is of any type or level or amount or category of volatility, differentiation, mutability, accessibility, addressability, capacity, performance and energy use, and which is based on any suitable technologies such as semiconductor, magnetic, optical, paper, and others.

### DETAILED DESCRIPTION OF THE DISCLOSURE

In a typical assembly process of building elements, an assembler (a workforce which assembles building related elements) is required to consult multiple complex drawings which describe in detail the target structure.

This tedious effort of reading the details from the drawings is time consuming and prone to errors. Specifically, with regard to framing structures, the assembly effort may be simplified if some of the assembly details are printed in advance on the framing structure components themselves. However, roll-forming machines (which are used to create framing structure components such as, by way of non-limiting example, studs and tracks), have no inherent accurate printing capabilities, and since printing is not the primary or original function of the machine, the printing functionality and precision are quite limited because the machine's localization abilities do not extend to the printing add-on.

In addition, other problems may arise with existing design software tools which generate cnc commands. According to certain embodiments, assembly instructions are inserted into appropriate locations in the CNC command/program file e.g., as described herein. Proper labels are generated according to object orientations, and label placement and cue placements are computed, all e.g., as described herein. Hence, the framing structure may be handled in isolation. In cases where other framing objects are derived from this specific structure any inheritance features are limited to the framing structure alone and may contradict the high-level aspects of the building hierarchy.

In the current specification, “framing structure objects” may be interchanged with “framing objects” and “frame structure components”. it is appreciated that studs and tracks are non-limiting examples of such objects.

It is appreciated that state of the art software such as Revit may define a host or host family which has plural children or child families and may be a root node for the “children”. Then child families may inherit parameters or features (“inheritance features”) which were defined in the host. For example, plural apartments in the same building may share the same design generally, but certain rooms/walls may differ due to small variations between apartments e.g. internal wall module placements or due to larger variations e.g. apartment 001 on floor 1, is a mirror image of apartment 002 on the same floor.

In steel based modular construction, closed wall panels or floor and roof cassette components, are comprised of a steel framing structure. One of the most common framing structures components are steel studs and tracks. The machine that is used to form these components are known as roll-forming machines.

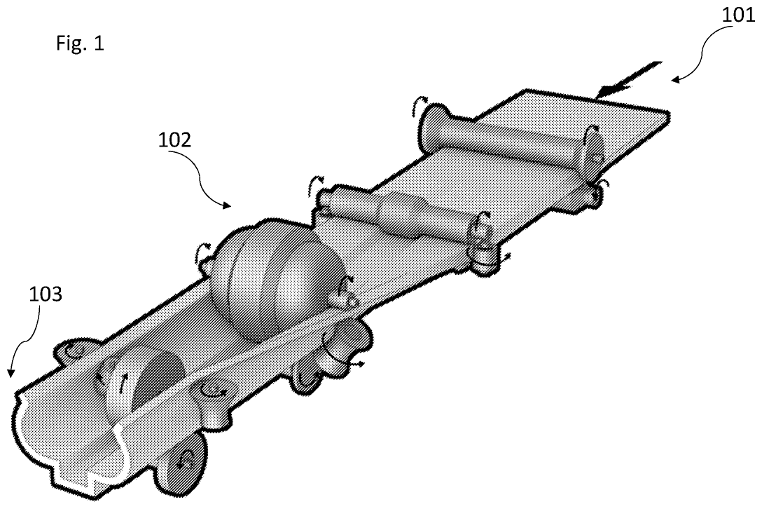

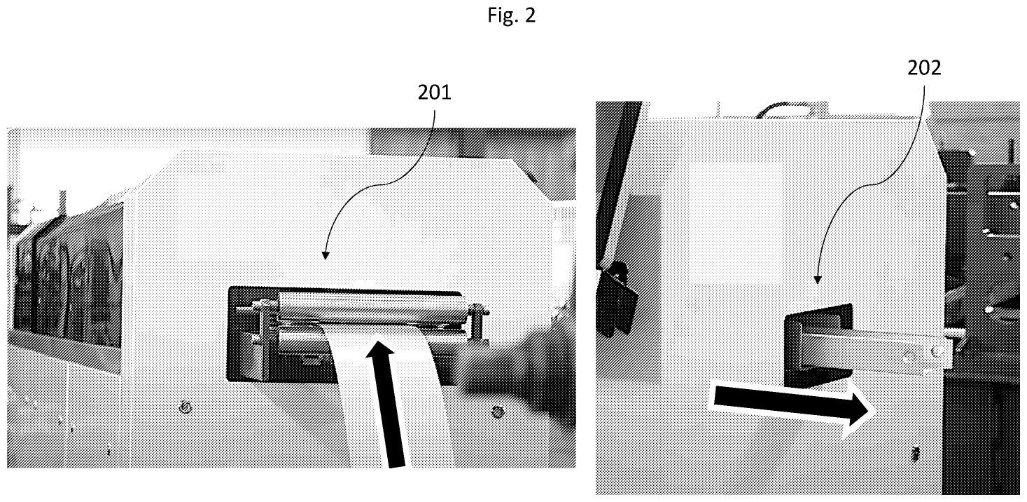

The roll-forming process involves the continuous bending of a long strip of sheet metal (typically coiled steel) into a desired cross-section, as presented in FIG. 1. The strip (101) passes through sets of rolls mounted on consecutive stands (102), each set performing only an incremental portion of the bend, until the desired cross-section (profile) is obtained (103). Additional mechanical adjustments (e.g., punching holes or apertures, cutting, etc.) may be applied to the manufactured parts as they roll through the machine itself. FIG. 2 presents an actual machine (e.g., roll-former), where the strip enters the machine at (201), and It is processed within (as presented by FIG. 1), and exits the machine at the desired form and cross section (202) and eventually is cut by the machine all according to pre-loaded computer numerical control (CNC) instructions. Roll-forming is useful for producing constant-profile parts e.g., studs and tracks, with long (typically as long as desired) lengths and in large quantities.

The dimensions and other characteristics of the studs and tracks may be customized according to specifics of project requirements. While roll-forming machines are capable of manufacturing studs and tracks, there is still some complicated labor involvement when assembling the complete framing structure itself.

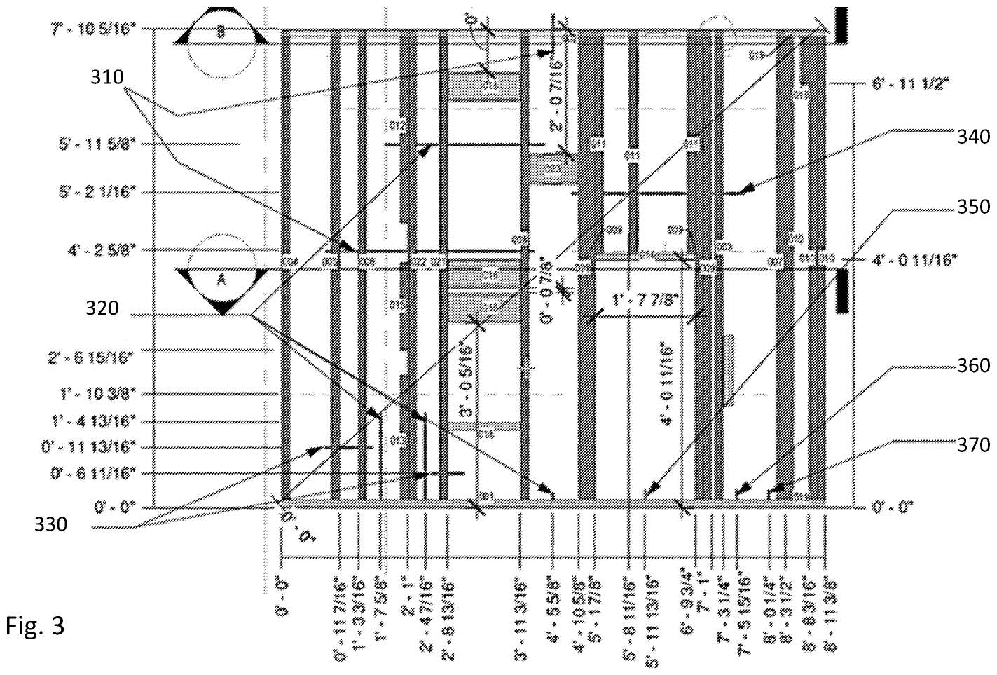

In a typical assembly process, an assembler is required to use multiple complex drawings (as exemplified by FIG. 3) which describe the low- and high-resolution details of the target structure. FIG. 3 is in fact a simplified version of an actual drawing, in which reference numerals 310-370 are each, in an actual drawing, replaced by an instruction to manually cut a hole of a certain diameter for a pipe to go through. Thus, reference numeral 310 replaces instructions to cut a 4″ hole in 2 locations indicated by 2 respective arrows from that reference numeral, reference numeral 320 replaces instructions to cut a 3.5″ hole in 3 locations indicated by 3 respective arrows from that reference numeral, and so forth. For example, consider studs 004 and 005 (FIG. 3). Stud 004 is the left most stud, positioned where the tracks begin. Stud 005 is positioned 11 7/16 inches to the right. It is expected that the assembler may measure this distance and may act accordingly. While stud 004 is positioned with its cross section opened to the right, stud 005 is positioned with its cross section opened to the left. This information may be retrieved from the bottom portion of the drawing, showing indications of ⊂(C) associated with 004, and ⊃ (backward C) associated with 005. Some of the studs may require additional effort. For example, stud 021 and stud 008 have steel plate connections 016 between them positioned at different heights (listed in the drawing). And/or, MEP elements may be fastened to or via certain studs or tracks. For example, if a cable of diameter d passes through plural studs, connectivity details may include locations along these studs at which a hole of diameter D>d needs to be punched.

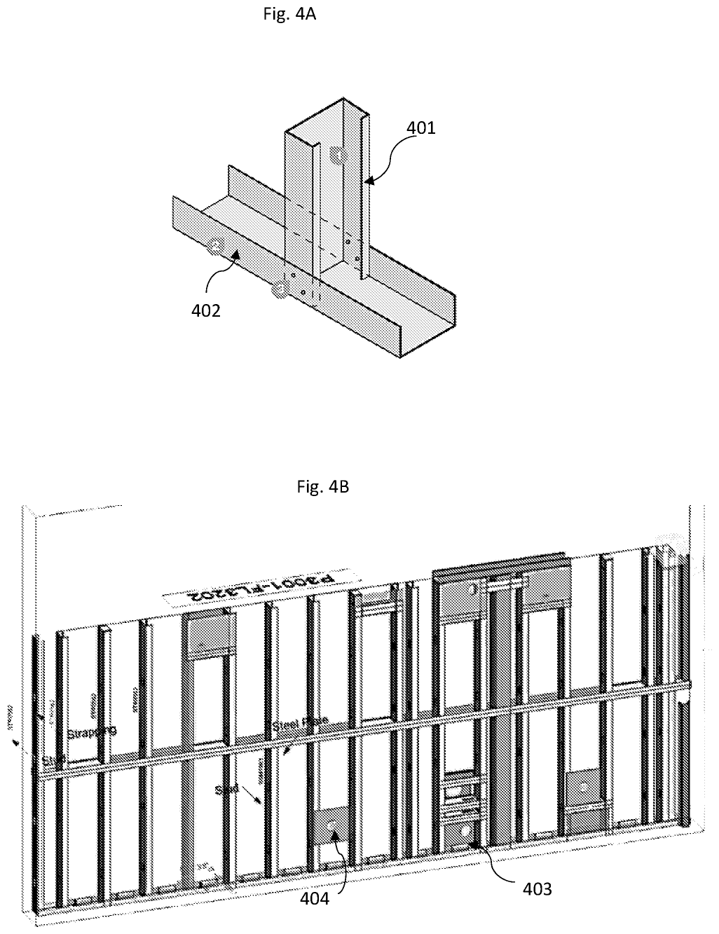

As described, the demand that the human user read details from drawings, while constructing the frame, is tedious, time consuming and a source of errors. In FIG. 4A an example of fixing a stud (402) into a track (401) is presented. A stud must, in some example designs, be attached to the track at a certain point and faced at a predefined direction, as dictated by the design. As presented in FIG. 4B, the attachment/installation/fastening points and orientation of each stud varies and/or as they are connected to different steel plates or other supporting objects (403, 404), these may require different arrangements. Not all studs are identical, meaning that they may vary in some mechanical aspect such as number of apertures and/or their related positioning etc. These variations complicate the assembly process (in which, typically, studs are fastened to tracks or vice versa, whether automatically or manually). To simply the assembly effort some of the assembly details may as described herein be printed in advance on the framing structure components themselves, e.g. as these components are manufactured. The CNC instructions sent to the roll-forming machine may contain both mechanical oriented commands (e.g., cut, punch, bend) and/or textual content printing commands or commands to print indicia, assuming that such printing commands may be processed by the machine.

Execution of a CNC operation (line in a CNC file e.g.) which performs the desired mechanical or printing functionality, requires only a short period of time, typically several seconds to tens of seconds, depending on factors such as, say, any or all of the command's complexity (“punch” vs “cut” vs “form”), the gauge of the rolled steel (thicker=more time), the dimensions being processed (“longer”=more time) and the roll former machine inherent performance (and cost). Thus, simplification of the (perhaps manual) process of fastening is obtained without appreciable added complexity/cost during the manufacturing stage.

Some machines, such as certain roll-forming machines, may have no inherent accurate printing capabilities; typically, printing on studs and tracks is achieved by using third-party printer add-ons which are loosely coupled with the roll-forming machine itself and which are not governed by high-precision localization circuitry which may be present in the machine itself for purposes of cutting or punching or bending (by way of non-limiting example) at a precisely determined location.

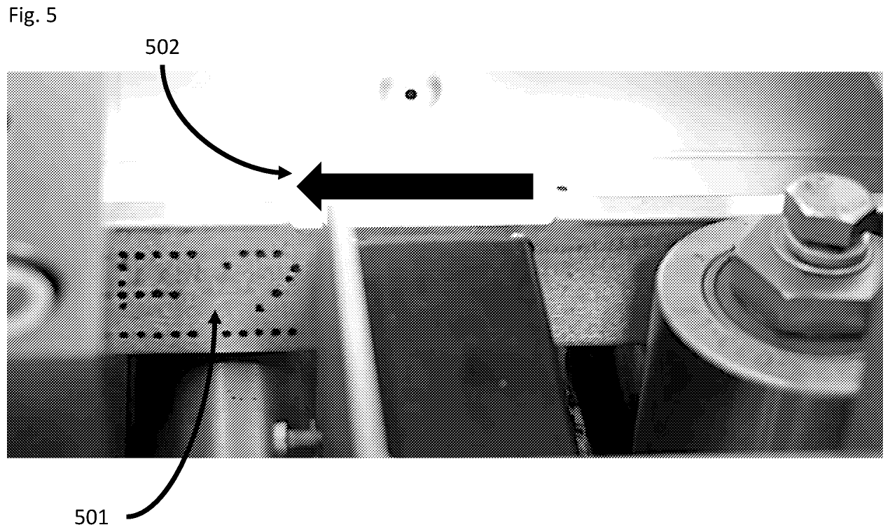

Although the integration or seamline between the printer and the machine itself may not be physically visible, nonetheless, if printing is not the primary function of the machine, the printing functionality and precision are limited (the machine's localization ability is not applicable to the printing functionality e.g.). For current printing applications which are focused on labeling part numbers or serial numbers this may be sufficient, yet for more complex applications e.g. as described elsewhere herein, this may be an implementation barrier e.g. as seen in FIG. 5, which may be overcome e.g. as described herein.

As described, existing design software tools e.g. for generating CNC instructions or implanting textual labeling into the manufacturing file itself typically disconnect between framing structure objects and their associated all-inclusive building elements: a building element (e.g., data record which represents a physical element such as a wall panel, floor cassette or other framed structure) is, on one hand, an integration of multiple elements including the steel frame, yet, on the other hand, a portion of a building construct which itself contains multiple building elements. For example, an object B may inherit its design from a parent object A, by virtue of inheritance properties between objects B and A defined via the software. Objects A, B may seem identical, but they are not, which has effect at the manufacturing stage. For example, the 2 objects may be mirror images due to building symmetry (opposing apartments) or specific apartment location/floor differences.

For example, room x in project y has a floor or wall which then by virtue of being a floor (or wall), inherits certain properties predefined by the software as characterizing all floors (or all walls).

However, when handling the framing structure of a specific building element, the previously mentioned software tools focus mostly on the framing structure production, focusing on the specific frame object, hence detaching this association (e.g., inheritance properties between objects) and losing the framing structure perspective. As a result, the framing structure may be handled in isolation, e.g. as described above.

For example, two otherwise identical or similar apartments in a building, facing the same direction, yet on different floors, may have some altered architectural kitchen area requirements (regarding, say, electrical outlet configuration, plumbing configuration) which may lead to differences in the specifics of the framing structures of the building elements which construct the kitchen. However, if, at some early stage, the framing structure of one kitchen is derived, then any particular changes in one apartment may require a designer to edit the manufacturing file directly as a result of these changes. Otherwise, the framing of both apartments may be manufactured under the assumption that they are identical. Thus, the framing structure design “jurisdiction” is separated from the high-level architectural design “jurisdiction”.

Certain embodiments of the invention, which may be provided separately or in any suitable combination, handle these limitations and facilitate additional functionalities.

It may be assumed that the framing structure details for manufacturing are known, and the current focus is only on providing accurate instructions for the assembler.

According to an embodiment, a method is provided which combines the use of inaccurate and accurate processes. A machine which physically processes a workpiece, such as a roll-forming machine, may be capable of handling mechanical functions accurately, hence punching holes or bending the steel roll material (say) may be done at precise locations. If a specific label is required for providing instructions, or for guidance to, or precision identification of a specific location (e.g., stud meets track), a punched hole (or similar) may accurately indicate and mark the assembly placement guide. The printer may provide, in addition, a label, with positional information (e.g., stud matching number, stud orientation, etc.) in the vicinity of the punched hole itself. The printed label itself is not used for assembly position placement and is only a cue indicating the relationship between components (e.g., stud X to be inserted at a certain direction). Thus, rough localization of the printed label, e.g. provided, say, by roll formers with add-on printing capabilities which are not governed by the roll former's high-accuracy localization, is sufficient to ensure that each label pertaining to fastening two components x, y is within the field of view of a manual worker who is assembling components x, y and does not need to be precisely positioned to the same resolution that an actual mechanical marking (typically) needs to be precisely positioned.

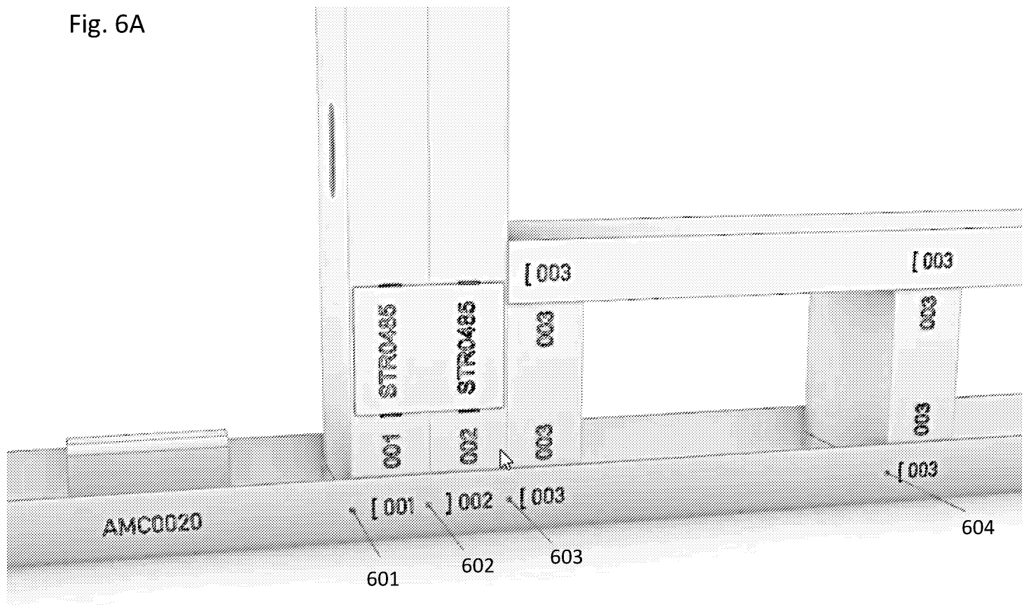

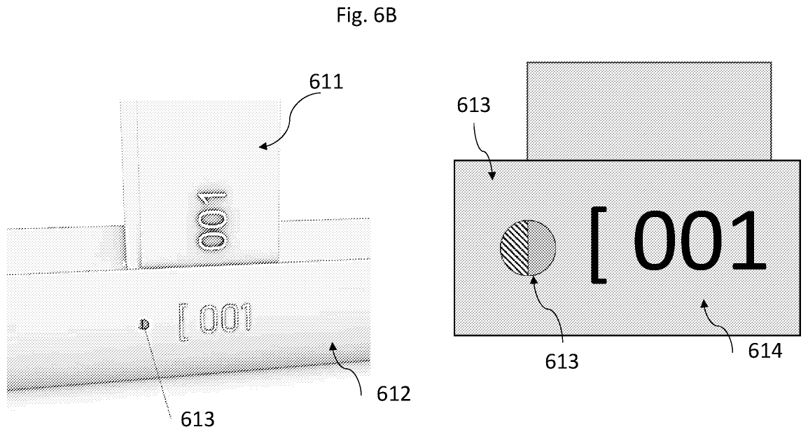

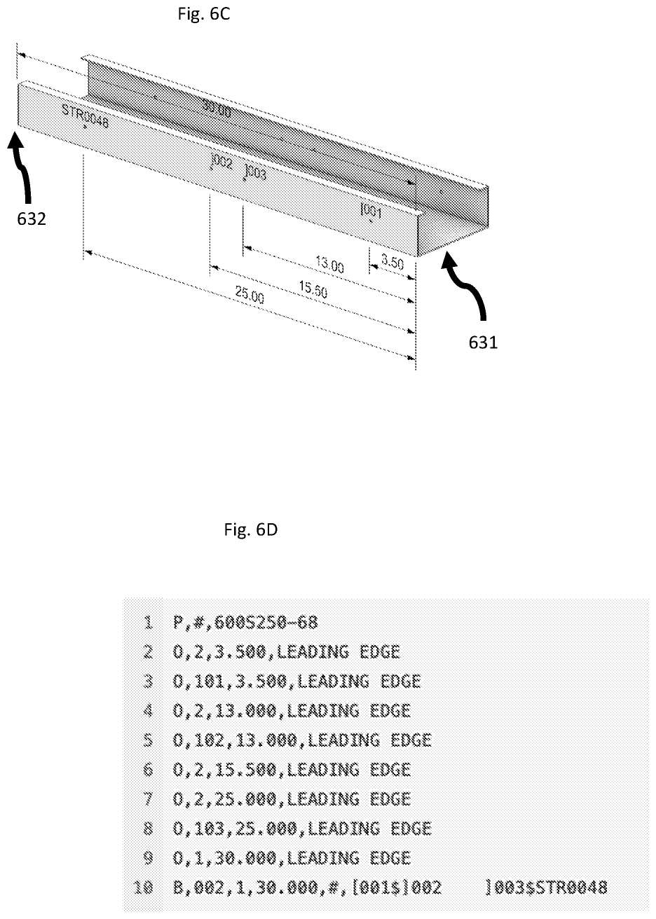

Reference is now made to FIGS. 6A and 6B. In FIG. 6A, an example portion of an example frame structure is presented, including a track (e.g., “AMC0020”), plural studs (e.g., “001”), and a metal plate (“STR0485”, not manufactured by the roll-forming machine, but to be installed as a portion of the frame). For example, the track “AMC0020” has four punched holes 601, . . . 604, each with printed text which is typically adjacent enough to the hole to be within the same field of view, for a human working to assemble the frame structure. The text typically indicates a unique identifier of a stud-type which should be deployed at that location/position (e.g. 001, 002, etc.; in the illustrated example, two studs of type 004 are shown assembled, topped by a track which similarly is imprinted with the text “[003”) and any required stud opening direction (e.g. using symbols such as [ and] to indicate that the stud's open end should face to the right or to the left respectively). FIG. 6B includes a zoom-in on the base of stud 001 (611) as it is inserted into the track (612). The printout (614) “[001” indicates, as a cue, the use of stud 001 with an opening towards the left side (when facing the drawing). The punched hole (613) (which indicates precisely the position of the stud) is used as a “spy hole” for visual inspection while placing the stud into the track. In the illustration, the stud has been fastened to the track at the correct location along the track, which is why exactly half of the spy hole is blocked. If more than half, or less than half, of the spy hole were to have been blocked, this would indicate e.g. to a human assembler that the stud has been fastened to the track at an incorrect location along the track.

In some cases, an existing hole (or any aperture, or any apparent mechanical marking feature) may already exist due to other framing design considerations, without any further need for additional punched holes. In this case, the pre-existing hole (or aperture etc.) may be used for assembly placement as well. An additional label may be printed adjacent the hole for complementing the assembly guidance.

All or any subset of the following features may be provided: For each connection point between 2 (or more) framing components additional assembly information should be added for one or more typically both components (both or only one of which may be manufactured by the roll-forming machine); the added information may be at or adjacent the location of a punched “spy hole”, corresponding to the precise location of the edge of the installed component which may be visually inspected for the correctness of the placement. The exact hole position may be determined using the exact dimensions of the components and the design guides; and/or the printed label (to be printed nearby the corresponding “spy hole”) may include the part number of the component to be attached or inserted, and additional characters (at least one) indicating the orientation of the component.

In a typical arrangement for printing, while roll-forming, the printer may print on one particular side of the framing component being created, as seen in FIG. 5. However, this may cause some complications for the assembler. When combining plural framing components, some may have the label writings faced towards the direction of the assembler, while other components may present the label faced towards the other side, due to rotations and turns of the framing component itself.

The reason for awkward label facing directions may be because the printing process is both one-sided and one-passed. In FIG. 5 the direction of printing follows the advancement of the metal sheet being rolled and formed (advancement direction 502). The printer has only one opportunity to print due to this advancement as seen in (501). In FIG. 6C, an example of a framing object is presented with (631) being the starting point (leading edge), hence the side which is first to exit the roll-forming machine, while (632) is the last side exiting the machine. Printing order starts from and may be relative to (631) and ends near (632) e.g., as previously discussed.

FIG. 6D presents a typical CNC “program” (a list of manufacturing instructions) used by a roll-forming machine manufacturer. Each manufacturer maintains its own “programing language” (the instruction set for operating and controlling the machine), yet they possess similar structures and functionalities. A typical program may start with some declaration header line (e.g., module name) followed by sequential instructions matching the physical direction flow of metal sheet through the machine. Each program line may include a positional value indicating where a stated function should be applied (e.g., where to punch a hole, where to print a label). In the specific case in FIG. 6D, the textual labels used for the program are all concatenated (typically separated by a system-recognized symbol e.g., a “$” sign) and appear as a batch update by the end of the program while labels are extracted according to their order using the instructions as described.

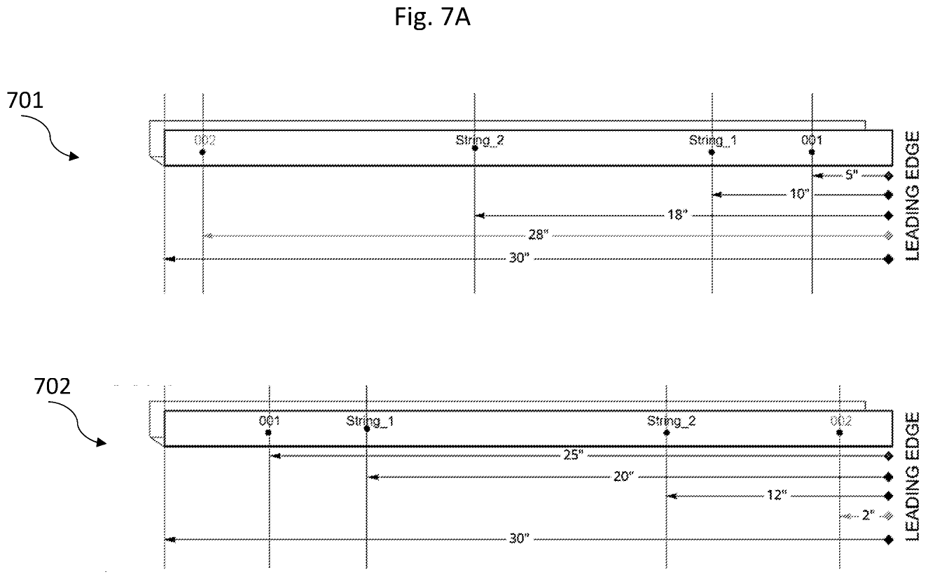

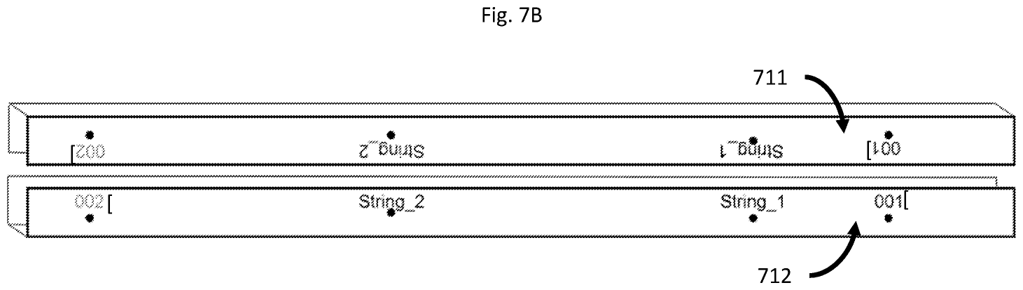

The roll-former is an example of a machine which performs a one-pass serialized process on a workpiece, because the rolled steel advances through the machine, and does not retreat or backtrack at any stage. As a result, at any given location there is only one opportunity to print and/or punch/cut/drill etc. As such, all instructions are serialized; line #1 is executed, and then line #2, etc. This typically corresponds to and follows a certain direction of installation e.g., as dictated by the orientation and installation operations, as seen, by way of example, in FIGS. 7A-7B.

Concatenation refers to printing a single label including two alphanumeric (say) strings, rather than printing a separate label for each of the two (say) strings.

Certain embodiments herein may resolve either one or both of the following two problems which may be inherent: first, the (human) assembler, when handling a framing object, may be forced to change sides for reading the labels on both sides of the framing construct, as framing object orientation may change, while the printed information exists only on one side. The assembler may need to physically adjust the construct, or change positions, which, in any case may be problematic due to the size of the framing construct, and the fact that the information on one side needs to be “remembered” when switching sides. Second, even if the one side printing regime is acknowledged, printing in advance on the side which may be faced, cannot be done directly, as the printed labels and punches may be wrongly placed both in their order and in their position. This may be resolved e.g., by changing the printed labels' order and/or related cues and/or adjusting printed orientations which may flip due to orientation change of the manufactured object (e.g., track).

Certain embodiments of the invention include the following process (“method I”) which may, as described below, fix these issues computationally. Assume that the roll-forming machine prints on the lower side of stud cross section C or the right side of a track cross section u which are considered the proper positions (if the machine is oriented differently, then the process may use a reversed scheme, upper side on the stud, left side on the track, and those may be considered as the proper positions). Method I may be combined with any other method herein and may comprise all or any subset of the following operations, suitably ordered e.g., as follows:

1) Next framing component is retrieved
2) Determine 3D orientation of the framing component:

| | |
|---|---|
| a. | If component is a stud, then determine if target position in assembly opens to the |

| right like the letter C or to the left like a backward C. | |
|---|---|
| i. | If not in proper position, the proceed with the reversing process (e.g., as |
| | described in operation 3) |
| ii. | If in proper position, proceed with normal printing and punching process |

| | |
|---|---|
| b. | If component is a track, then determine if target position in assembly is open |

| upward like the letter U or downward like an upside down letter U. | |
|---|---|
| i. | If not in proper position, then reverse e.g., proceed with the reversing |
| | process (e.g., as described in operation 3) |
| ii. | If in proper position, proceed with normal printing and punching process |

3) Perform reversing process as follows:

| | |
|---|---|
| a. | Retrieve stud or track length as L |
| b. | Open new text vector V (dimension N equal to the number of printouts) |
| c. | Initialize i with N (i = N) |

| | |
|---|---|
| d. | Retrieve next punch position Xi and associated label record Li |
| e. | At least once, reverse stud or track orientation characters e.g., C, U, reversed C or upside-down |
| | U, meaning that left-faced changed to right-faced and vice versa, while upper-faced changed |
| | to lower-faced, and vice versa. Typically, stud or track orientation characters (⊂, ⊃, ∪, ∩ also |
| | termed herein c, backward-c, u and upside-down u respectively) are reversed if facing |
| | information needs to be preserved when stud or track are flipped. |

| | |
|---|---|
| f. | Generate CNC text command with adjusted position (L-Xi) and printed label Li |
| g. | Store CNC text command in Vi |
| h. | Reduce i by 1 (decrement) |
| i. | If i > 0, then go to operation d, otherwise (j) append vector V to CNC instruction file |

4) Terminate if no more framing components, otherwise return to operation 1

In FIG. 7A an example of two tracks of a wall panel are presented. One track (701) may be installed as the lower portion of the wall while the other track (702) may be installed as the upper part. Plural studs (not shown) vertically connect between the two tracks. The printing and punching positions in (702) were reversed based on the (701) design and manufacturing instructions. For example, 001 (in 701) which was 5 inches away from the leading edge (first to exit the roll-forming machine) is translated to 001 (in 702) which is now 25 inches away from the leading edge (as the length of the track is 30 inches). In FIG. 7B the end result-2 tracks positioned (in this illustrated example) correctly, with the open side of one track facing the open side of the other track, like this: [ ] rather than like this [[ or like this]] or like this] [—is seen with printed directions both facing the same direction and/or perspective, as seen by an assembler. The assembler thus need not go back and forth from, say, the back of the frame and the front. All instructions are seen from, say, the front position, and are seen at their proper locations. As can be seen, the printed and punched information on the upper and lower tracks, correspond with one other e.g. in the sense that a stud meets the lower part (certain location and orientation) and ends at the upper part (matching location and orientation as it doesn't twist in the middle).

It is appreciated that the illustrated “strings” may refer to any alphanumeric string or any other indicia.

During assembly, a building element e.g., stud 001, is to be fastened to the bottom track and top track, with its open side facing right, as is indicated in the indicia added to the top and bottom tracks at their right-hand ends. It is appreciated that the indica are reversed and/or upended e.g., as shown, depending on the anticipated position of human handlers vis a vis the building elements being assembled, when each label is actually read.

The following terms may be interchanged within the present disclosure: “building element”, “building component”, “framing component”, “framing object”.

It is appreciated that a wall (say) may include other components, in addition to the frame yielded by the studs and tracks, such as components (foam or other filling, and/or additional layers laid on either or both sides of the frame) providing acoustic and/or fire and/or thermal and/or structural and/or aesthetic/decorative properties, and/or such as MEP elements and/or smart home elements which may be deployed within the frame and/or elsewhere. For example, aesthetic properties may be provided by adding a layer of solid surface material (such as Dupont's Corian) on one or both sides of the frame. If the wall is an external wall, an exterior cladding layer may be added on the external-facing side of the frame.

It may occur that adding punched markers is redundant e.g., due to pre-existing markers as a result of the frame structure design. However, other cases need to be considered.

Limitations of the roll-forming machine are typically manifested as the minimum distance between apertures and punching holes (or dents). Assembly limitations are limitations due to assembly difficulties which may impose near edge labeling or punching. Practically, both of these limitations are dismissed or handled during the design stage, as the designer accommodates for both the roll-forming equipment restrictions and assembly constraints.

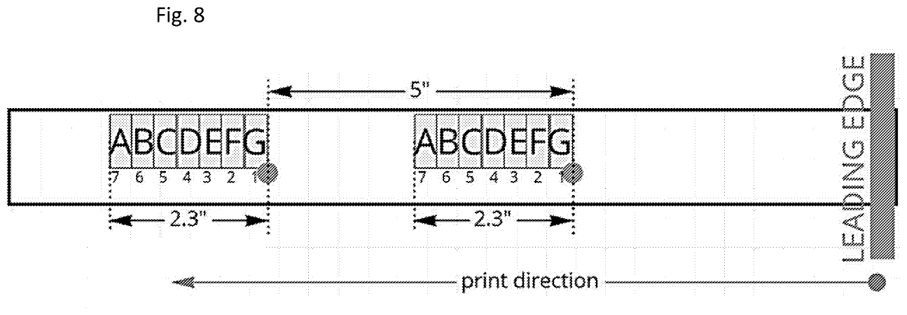

However, an additional case arises due to the printing process itself, when labels may either overrun, or are positioned too close. In FIG. 8, two labels on an object are presented. The label length is dependent on both the number of characters (included in the label) and the character width. Some spacing may exist between the labels as a result of the design itself (e.g., stud spacing). In a label overrun scenario, a label may overlap a subsequent label due to label lengths and object positioning (e.g., too near objects with too long labels). This may dictate some printing restrictions which may need to be respected, such as using a minimum amount of information to be conveyed using the print-out.

Another case, which is even more likely to occur, is a limitation which is typically imposed as a result of the combined operation of the roll-forming function (which starts and stops the rolling process) and the printer head re-positioning prior to processing the next label, hence translating to a minimal distance requirement between occurrences of adjacent labels. This case may be handled automatically in the following way.

The number of characters in a label may determine the label length. If the current position to start printing is X[i] and the current label physical length is Len (L[i]) (where Len(q) is a function which determines the physical printing length of a label q), then the difference in positions, X[i+1]−X[i], should be greater than Len (L[i])+P, where X[i+1] is the next position, and P is the minimal distance between two adjacent labels, as dictated by the printer.

Certain embodiments of the invention may process the labels to be printed and detect such occurrences. The following process is an example of a method, “method II”, which detects these and, accordingly, adjusts labels, including if and as suitable, left-right reversal and/or upending of indicia. All or any subset of the following operations may be provided, suitably ordered e.g., as follows:

| 1) | Create a modified label list L′ which may be initialized to the original label list (L) values | |
|---|---|---|
| 2) | Initialize pointer R to 0 (R = 0), | |
| 3) | Process next label, L[i], to be positioned at X[i] (starting point) | |
| 4) | If no more labels exist, end process by going to operation 8 | |
| 5) | If i = 1 then compute the physical length of the label, Len(L[i]) and adjust R to point to the | |
| | end of the first label and return to operation 3 | |
| 6) | If i > 1 (meaning, not the first label) then: | |
| | a. | Check if adjacent labels “too close”, (X[i] − R) < P |
| | b. | If “too close”, then modify preceding label L′[i − 1] |

| i. | Take original preceding label |
|---|---|
| ii. | Pad L′[i − 1] with spaces (number of spaces determined by the dividing the |
| | distance X[i] − R by the character width) |
| iii. | Append label L[i] to L′[i − 1] |
| iv. | Set L′[i] to null |
| v. | Set new R value to point to L′[i − 1] label end (add physical length of L′[i − 1] |

to current R)

| | |
|---|---|
| c. | If not “too close”, then no modifications are required, and only set the new R value |
| | to point to L′[i] label end |

| | |
|---|---|
| 7) | Go to operation 3 |
| 8) | Use modified label list L′ (e.g. as shown pictorially in FIG. 6d) instead of original label |
| | list L |

The above process may be modified or extended to handle the case if multiple labels appends (of the same label) are required, for example, when L[i], L[i+1], L[i+2] may need to be concatenated due to printer limitations. This may be done by modifying operation 6 in the above process to review previous labels if the preceding label is determined null e.g., in operation 6.b.iv described above.

Printing one long label, rather than plural shorter labels, may be more optimal e.g., because their printed locations may incur some offset due to the imperfect accuracy of the printer. For example, M×N asterisks may be printed in a row as one label may have a different physical printed length if printed as M consecutive labels of N asterisks.

The process focuses on a likely case of labels which are too close to be printed, however the process may be modified to trim labels if overruns occur, e.g. by using a smaller font (unless the original font is already at minimal font size), or less spacing, or otherwise shortening the original label e.g. to preserve a certain physical space between labels. Or labels may each have more than one version, with a preference to use the most understandable version. However, say, leading zeros may be trimmed if labels cannot fit. if a label includes so much information that it cannot be shortened to fit, this may flag an error while processing and creating the CNC file. This may call for manual adjustments of the labels if existing shortening measures e.g. automatic trimming/font size reduction cannot resolve the issue, or an error notification may be flagged, which may be resolved by further handling by a human designer, for example.

In the above description, it was assumed that a detailed framing structure file exists and a corresponding manufacturing CNC file may be created. Some embodiments are configured to extract and create these corresponding files.

Framing structure design files are typically loosely coupled with the original architectural design files e.g., because attention is on manufacturing framing components (such as studs), without considering the framing structure which includes these components and/or the original architectural design. This detachment and changed emphasis may require a great deal of manual file tracking and editing to overcome design deviations (changes in the original building design) and design variants (due to specific adaptations of initially identical building elements).

Certain embodiments of the invention provide a fully synchronized design by extraction of the framing structure out of any current version of the complete building element design. The original building element design file (e.g., a wall panel, floor cassette) may be used to generate an on-the-fly framing structure design file which typically provides a full structure assembly perspective and/or a component based standpoint.

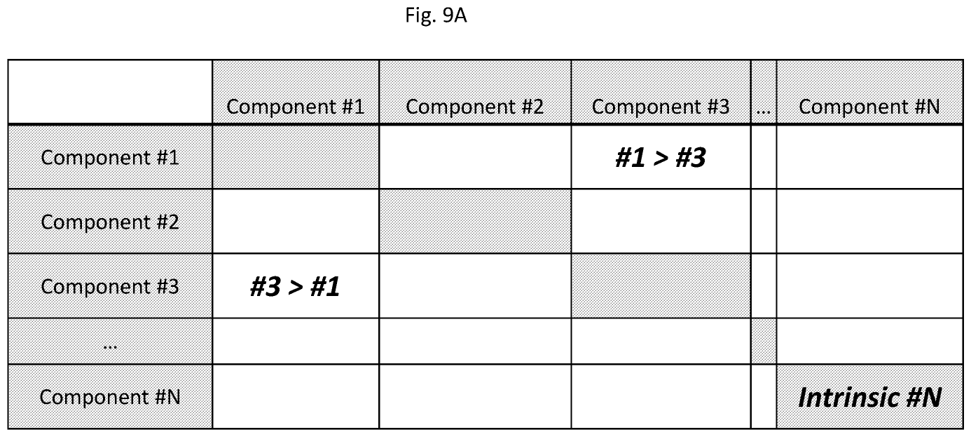

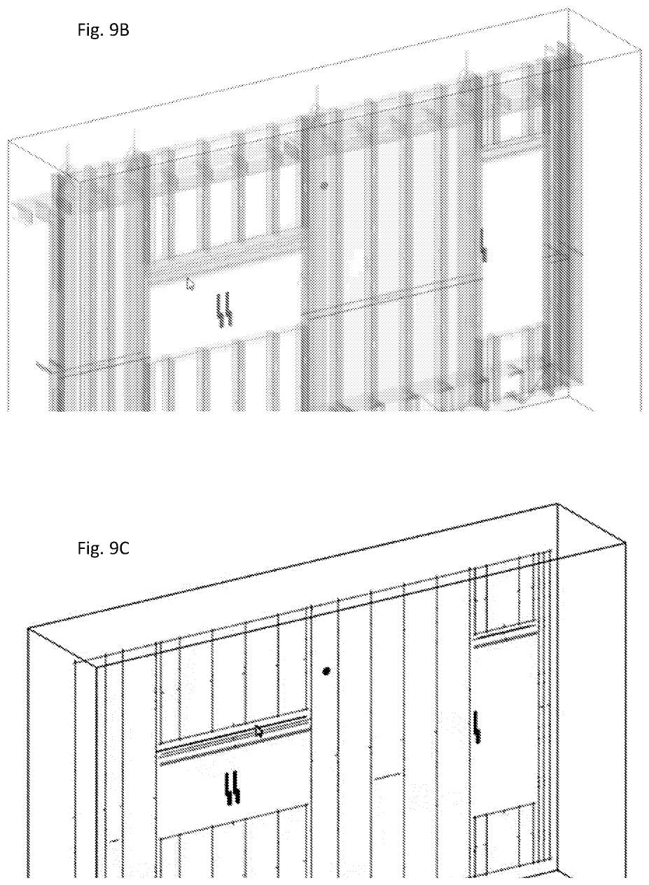

FIG. 9A describes a connectivity matrix which may be used (typically by generating the matrix, storing same as cache, and then retrieving data from the matrix directly from the cache rather than, say, by querying (e.g. using Autodesk/Revit queries) each time that data needs to be retrieved) by certain embodiments of the invention. The matrix may be used by software and/or may be presented to a human user. The number of rows and the number of columns of the matrix may be respectively equal to the number of framing components. For example, if the structure includes 2 tracks and 10 studs, then the matrix dimension may be 12 by 12. Or, the matrix dimensions may be 2 by 10. If the structure includes 2 tracks, 10 studs and other elements such as 3 plates which are also fastened to framing components, the matrix dimension may be 15 by 15.

Each matrix cell positioned at Row X, Column Y contains a detailed record describing the connectivity details of component Y installed into or on component X. For example, cell (1,3) in FIG. 9A describes the connectivity details (installation) of component (e.g. stud) #3 into component (e.g. track) #1. The details may include, say, an indication of locations x and/or y along components 1 and/or 3 respectively, at (each of) which, or adjacent each of which, a hole of diameter d is required in order to accommodate a screw which will fasten together components 1 and 3 and/or a spy-hole is required and/or indicia is required to represent the orientation/s of the stud and/or track. The cross-diagonal matching cell at Row Y, Column X, describes as well the connectivity arrangement between both components, but from a different perspective-details of component X installed into or on component Y. Although this may seem identical from a connectivity point of view (as if X is connected to Y, then Y is connected to X) yet the details may differ. For example, X may be attached to Y using screws inserted first through X, while no screws may be deployed from Y. Therefore, it is advantageous to maintain both matrix elements and records. If no connectivity exists between components, then their corresponding matrix cell may be vacant (null).

The diagonal cells of the matrix have a different use, as components are not connected to themselves. There are some intrinsic data relevant to a component itself, such as its own dimensions or any other mechanical or geometric aspects of the component itself. Therefore, the diagonal elements are reserved for describing the components themselves.

This matrix may be replaced by any data structures which provide similar functionalities as the matrix representation. For example, holding the diagonal intrinsic data of the components in a different database or data structure provides a similar purpose, or holding one table describing all possible connections between components may be also regarded as an equivalent representation to the matrix. Generally, any data structure may be used which stores e.g. in a cache, connectivity details of components, for various pairs of components and, typically, intrinsic data relevant to a component itself, such as but not limited to a matrix.

Any suitable cache or cache technology may be employed to generate the cache and to retrieve data therefrom, e.g. as described in this Wiki entry whose disclosure is hereby incorporated by reference: https://en.wikipedia.org/wiki/Cache (computing).

To maintain a dynamic connectivity matrix, e.g. for use as described above, connectivity data may be extracted from the original architectural file of the building element (e.g., wall panel, floor cassette), typically offline, and may be stored in the matrix. Software tools such as Revit by Autodesk allow for query-like functions for data extraction from the matrix, which may be stored in memory e.g., may be cached, whereas the original files of the building element/s may not be cached. Other software tools such as SolidWorks provide similar data access.

The method (“method III) for constructing or updating the connectivity matrix may be combined with any other method herein, and may comprise all or any subset of the following operations, suitably ordered e.g., as follows:

1) Retrieve and open Building element file (e.g., wall panel etc.)
2) Query for next component or if no more components go to operation 5
3) Is component related to the framing structure? If not, go back to operation 2
4) If framing is related:

| a. | Retrieve intrinsic parameters including but not limited to: | |
|---|---|---|
| | i. | Physical dimensions |
| | ii. | Type and if created by roll-forming (by type) |
| | iii. | List of apertures, holes, and any other mechanical modifications including |
| | | size, location, etc. |

| | |
|---|---|
| b. | Retrieve list of framing components attached to (e.g., geometry crossings, etc.) |
| | When a wall's file is accessed, for example, a typical format may include a list of |
| | components used by the wall. Eventually this information may be used for |
| | manufacturing the wall (e.g., roll former related) and in addition generate the |
| | corresponding labels and cues. FIG. 6D is an example outcome of this matrix |
| | creation process. For each component on the previous list, determine method of |
| | attachment (select by case) and role (active = component attaches to, |
| | passive = component being attached to), orientation (cross section opening |
| | right/left/up/down) |
| c. | When done go to operation 2 |

5) Count number of framing components, N
6) Assign integer numbers to components from 1 to N
7) Create connectivity matrix NxN
8) For each component I (I = 1 . . . N), populate a corresponding row

| a. | Store intrinsic information of the component in cell (I, I) | |
|---|---|---|
| b. | Go over all cells of the row (skip on cell I, I) | |
| | i. | For each cell (I, J) determine if component #J is connected to component #I |
| | | (active). |
| | ii. | If yes, then store at cell, connectivity information #J on #I |
| | iii. | If no, then set cell to null |

| | |
|---|---|
| c. | Next component (equivalent to next matrix row) |

9) End of connectivity matrix create/update

The above process may be adapted for different data structures if the matrix format is replaced. In addition, additional improvements of the matrix structure may be applied. For example, as many studs of a framing structure are identical (or almost identical), it may be advantageous to determine similarities in advance, as eventually this may greatly simplify any target manufacturing or validation processes. Similarity of components may be tested on either an intrinsic level (e.g., similar geometry) or connectivity based (e.g., all components which are attached to same component), or a combination of both.

The connectivity matrix may be tightly coupled with original design file and may be synced with it more than once. The connectivity matrix is a suitable starting point for multiple applications e.g., as described below.

In FIG. 9B, a framing structure is presented in a 3D-like view. Although the visual representation provides a clear near real-life image of the framing structure, it is cluttered with unnecessary details for some of the assembly procedures, possible automation, and validation of the assembly process. FIG. 9C, on the other hand, is built and presented using only the relevant data from the connectivity matrix e.g., the connectivity matrix may be derived from the data illustrated in FIG. 9B, and FIG. 9C may be derived from that connectivity matrix. As the matrix data is completely focused on structure and connectivity, the visual representation is a clean version of FIG. 9B.

For example, if a program file containing CNC-related commands for the roll-forming machine is required, then the connectivity matrix contains pinpointed information which may be required for manufacturing.

For example, a row of the matrix, I, representing component #I may be first examined starting with cell (I,I). The intrinsic information, e.g. on the diagonal of the matrix, may first reveal if the component is intended to be manufactured by roll-forming or not (e.g., steel plate). If intended for roll-forming creation, the intrinsic file may be used to determine certain typically essential geometrical properties of the component, such as all or any subset of: its length, cross section profile, location of holes and apertures, etc. Other cells (I,J) (J≠I) may be used for determining additional information for reducing assembly complexity, as described elsewhere herein. For example, if cell (I,J) indicates that component #J is actually a stud to be inserted into the track (component #I), then an appropriate label and punch hole location may be added to the program file.

A use-case which is facilitated by the matrix itself, is an automated validation process. As demonstrated by FIG. 9C, the complex framing structure of FIG. 9B is reduced to a simplified skeleton which may be overlaid over an image of the assembled frame and compare the basic geometry of both structures. Other applications which do not require the detailed description of the framing structure or the building element itself may also make use of the simplified structure.

It is appreciated that any known technology or ink/toner for printing (or other marking techniques such as engraving) on steel or metal may be employed, such as but not limited to those described in the following links which are hereby incorporated herein by reference: https://www.kaocollins.com/inktank/inkjet-printing-metal/#:˜:text-Solvent%2Dbased%20inkjet%20inks%20are,%E2%80%9Cbites%E2%80%9D%20into%20metal%20surfaces.

Any aspect of roll-forming technology may be combined with the disclosure herein, such as but not limited to those described in the following link which is hereby incorporated herein by reference: https://www.iqsdirectory.com/articles/roll-forming.html.

It is appreciated that software may be configured to retrieve data from the matrix, at any point of time prior to manufacturing (and/or any other applications which may require framing related information) and/or as a scheduled background process (e.g., refresh/sync).

An advantage of certain embodiments is that a machine which is not able to print at an accurate location, may still be used to present information pertaining to a specific location. This may be done by printing the information on, say, a stud or track, adjacent the specific location, and also punching a hole or otherwise marking the location, using accurate mechanical operations of the roll-former. The hole (say) which has been punched at the fully accurate position, in conjunction with the information aka label which is printed at a less accurately determined position adjacent to the hole's fully accurate position (e.g. accurate at the desired resolution) achieves the desired effect.

It is appreciated that terminology such as “mandatory”, “required”, “need” and “must” refer to implementation choices made within the context of a particular implementation or application described here within for clarity, and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order, including simultaneous performance of suitable groups of operations, as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order, i.e. not necessarily as shown, including performing various operations in parallel or concurrently, rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices, each including at least one processor and/or cooperating input device and/or output device and operative to perform, e.g., in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g., in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g., by one or more processors. The invention shown and described herein may include (a) using a computerized method to identify a solution to any of the problems or for any of the objectives described herein, the solution optionally including at least one of a decision, an action, a product, a service, or any other information described herein, that impacts, in a positive manner, a problem or objectives described herein; and (b) outputting the solution.

The system may, if desired, be implemented as a network e.g., web-based system employing software, computers, routers, and telecommunications equipment, as appropriate.

Any suitable deployment may be employed to provide functionalities e.g., software functionalities shown and described herein. For example, a server may store certain applications, for download to clients, which are executed at the client side, the server side serving only as a storehouse. Any or all functionalities e.g., software functionalities shown and described herein, may be deployed in a cloud environment. Clients e.g., mobile communication devices, such as smartphones, may be operatively associated with, but external to the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis e.g. triggered only by determinations that x is true and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may, for example, comprise changing the state or condition, or may more generally cause any outcome which is technically advantageous given the state or condition or data, and/or may prevent at least one outcome which is disadvantageous, given the state or condition or data. Alternatively, or in addition, an alert may be provided to an appropriate human operator or to an appropriate external system.

Features of the present invention, including operations, which are described in the context of separate embodiments may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art, and particularly, although not limited to, those described in the Background section or in publications mentioned therein.

Conversely, features of the invention, including operations, which are described for brevity in the context of a single embodiment or in a certain order may be provided separately or in any suitable sub-combination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g., as illustrated or described herein.

Devices, apparatus or systems shown coupled in any of the drawings may in fact be integrated into a single platform in certain embodiments, or may be coupled via any appropriate wired or wireless coupling such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof, may also be provided as methods and operations therewithin, and functionalities described or illustrated as methods and operations therewithin may also be provided as systems and sub-units thereof. The scale used to illustrate various elements in the drawings is merely exemplary and/or appropriate for clarity of presentation, and is not intended to be limiting.

Any suitable communication may be employed between separate units herein e.g. wired data communication and/or in short-range radio communication with sensors such as cameras e.g. via Wifi, Bluetooth, or Zigbee.

It is appreciated that implementation of aspects herein via a cellular app is an example implementation and, instead, embodiments of the present invention may be implemented, say, as a smartphone SDK, as a hardware component, as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network, or is tethered directly or indirectly/ultimately to such a node).

Any operation or characteristic described herein may be performed by another actor outside the scope of the patent application, and the description is intended to include apparatus, whether hardware, firmware, or software which is configured to perform, enable, or facilitate that operation, or to enable, facilitate, or provide that characteristic.

The terms processor or controller or module or logic as used herein are intended to include hardware such as computer microprocessors or hardware processors, which typically have digital memory and processing capacity, such as those available from, say Intel and Advanced Micro Devices (AMD). Any operation or functionality or computation or logic described herein may be implemented entirely or in any part on any suitable circuitry including any such computer microprocessor/s as well as in firmware or in hardware or any combination thereof.

It is appreciated that elements illustrated in more than one drawing, and/or elements in the written description, may still be combined into a single embodiment, except if otherwise specifically clarified here within. Any of the systems shown and described herein may be used to implement or may be combined with, any of the operations or methods shown and described herein.

It is appreciated that any features, properties, logic, modules, blocks, operations or functionalities described herein, which are, for clarity, described in the context of separate embodiments, may also be provided in combination in a single embodiment, except where the specification or general knowledge specifically indicates that certain teachings are mutually contradictory, and cannot be combined. Any of the systems shown and described herein may be used to implement or may be combined with, any of the operations or methods shown and described herein.

Conversely, any modules, blocks, operations or functionalities described herein, which are, for brevity, described in the context of a single embodiment, may also be provided separately or in any suitable sub-combination, including with features known in the art. Each element e.g., operation described herein, may have all characteristics and attributes described or illustrated herein, or according to other embodiments, may have any subset of the characteristics or attributes described herein.

1. A method for manufacturing at least one individual building component for connection with additional building components, the method comprising:
manufacturing at least one individual building component for subsequent building of a structure by connection of the individual building component with additional building components, using a roll-forming machine which has a controller configured to read machine-readable CNC instructions; and
using the roll-forming machine for adding at least one marking to the individual building component, wherein said marking facilitates subsequent connection, of the building component, to at least one additional building component,
wherein said marking comprises at least one hole in the individual building component,
wherein said hole is deployed at a position, along the individual building component, at which a second building component is to be connected to the individual building component;
and wherein said hole is circular defining a center-point of the circle which is deployed at said position such that, once the second building component is connected, a human operator can look through said hole and discern that half of the hole is now blocked by the second building component, whereas none of the hole was blocked before the second building component was connected.

2. The method of claim 1, wherein said at least one individual building component comprises first and second articles, wherein said first article's connection to at least one additional article differs from said second article's connection to at least one additional article, and wherein said first and second articles are identical, except for plural first and second markings on said first and second articles respectively.

3-5. (canceled)

6. The method of claim 1, wherein said manufacturing includes detaching said individual building component from a roll of raw material fed into the roll-forming machine, and wherein said adding occurs before said detaching.

7. The method of claim 1, wherein said marking comprises printed indicia and said adding comprises printing said indicia on said individual building component.

8. The method of claim 7, wherein said indicia are printed on a location selected to be visible not just before said individual building component is connected to said second building component, but also after said individual building component is connected to said second building component.

9. The method according to of claim 7, wherein at least one of said indicia is printed on a location selected to be visible not just before said individual building component is connected to said second building component, but also while said individual building component is being connected to said second building component.

10. The method of claim 7, wherein said indicia comprise text which is read in a given order and is printed in an order other than said given order, such that alphanumeric characters, which are read later, are printed earlier.

11. The method of claim 7, wherein said indicia comprise text and wherein said printing comprises punching a mirror image of said text on a first side of each building component for only a subset of building components manufactured by said method to enable said text to be read from a second, opposite, side, wherein the subset includes building components whose second side will be visible, when later connected to other building components, and does not include building components whose first side will be visible, when later connected to other building components.

12. The method of claim 7, wherein said indicia comprises an indication of a desired orientation of the individual building component, when the individual building component is being connected to the second building component.

13. The method of claim 12, wherein said indication comprises a representation of the individual building component's cross-section, oriented as the cross section is desired to be oriented, when the individual building component is being connected to the second building component.

14. The method of claim 1, wherein said marking comprises at least one hole in the individual building component.

15. The method of claim 14, wherein said hole is deployed at a position, along the individual building component, at which the second building component is to be connected to the individual building component.

16. The method of claim 15, wherein the roll-forming defines an axis of operation along which the roll is paid into the machine, and wherein said position comprises an axis perpendicular to said axis of operation.

17. The method of claim 15, wherein said hole is circular defining a center-point of the circle which is deployed at said position along an axis perpendicular to the roll-forming's axis of operation such that, once the second building component is connected, a human operator can look through said hole and discern that half of the hole is now blocked by the second building component, whereas none of the hole was blocked before the second building component was connected.

18. The method of claim 1, wherein said adding is controlled by said machine-readable CNC instructions.

19. The method of claim 1, wherein said machine-readable CNC instructions, which control said adding, are non-identical for at least one pair of building components, manufactured by said roll-forming machine, which are identical in structure but are differently connected to other building components.

20. The method of claim 1, wherein said marking is a local marking which occurs at one location along the individual building component, rather than along the individual building component's entire length.

21-26. (canceled)

27. The method of claim 1, further comprising modifying a command file storing said CNC instructions machine-readable by the controller of the roll-forming machine to include a marking including at least one label and/or at least one shape and/or at least one hole punch, thereby to yield a computer program product comprising said command file as modified, and wherein the controller reads the command file as modified, to control said manufacturing.

28. A computer program product, comprising a non-transitory tangible computer readable medium having computer readable program code embodied therein, said computer readable program code adapted to be executed to implement a CNC-controlled roll-forming method comprising:
manufacturing at least one individual building component for subsequent building of a structure by connection of the individual building component with additional building components, using a roll-forming machine which has a controller configured to read machine-readable CNC instructions, and
using the roll-forming machine for adding at least one marking to the individual building component, wherein said marking facilitates subsequent connection, of the building component, to at least one additional building component
wherein said marking comprises at least one hole in the individual building component,
wherein said hole is deployed at a position, along the individual building component, at which a second building component is to be connected to the individual building component,
and wherein said hole is circular defining a center-point of the circle which is deployed at said position such that, once the second building component is connected, a human operator can look through said hole and discern that half of the hole is now blocked by the second building component, whereas none of the hole was blocked before the second building component was connected.

29. A system comprising at least one hardware processor configured to carry out
a CNC-controlled roll-forming method, the method comprising:
manufacturing at least one individual building component for subsequent building of a structure by connection of the individual building component with additional building components, using a roll-forming machine which has a controller configured to read machine-readable CNC instructions, and
using the roll-forming machine for adding at least one marking to the individual building component, wherein said marking facilitates subsequent connection, of the building component, to at least one additional building component
wherein said marking comprises printed indicia and said adding comprises printing said indicia on said individual building component
And wherein said indicia comprises a representation of a cross-section of a constant-profile component which is to be connected to the individual component, wherein the representation is oriented as the constant-profile component is to be oriented, relative to the individual component.

30. (canceled)
